(19) United States
(12) Patent Application Publication
(10) Pub. No.: US 2025/0007199 A1
(43) Pub. Date: Jan. 2, 2025

(54) HOUSING ASSEMBLY FOR A CONNECTOR, CONNECTOR AND CONNECTION ASSEMBLY

(71) Applicant: TE Connectivity Solutions GmbH, Schaffhausen (CH)

(72) Inventors: Vijeth CHANDRASHEKAR, Bangalore (IN); Praveenkumar HIRIYANNAPPA, Bangalore (IN); Naveena HEDDANAHALLY LAKSHMEGOWDA, Bangalore (IN); Gurumurthy C R, Bangalore (IN); Fredderik ELTROP, Bensheim (DE)

(21) Appl. No.: 18/752,497

(22) Filed: Jun. 24, 2024

(30) Foreign Application Priority Data
Jun. 28, 2023 (IN) 202341043322

(51) Int. Cl. H01R 13/502

(52) U.S. Cl. CPC H01R 13/502

(57) ABSTRACT

A housing assembly for an electrical connector that is intermateable with a mating connector includes a connector housing and a cover element attachable to the connector housing, wherein the housing assembly further comprises at least two exit openings for passing electrical wires, wherein the at least two exit openings are mutually angled at 90° or more, and wherein at least one of the exit openings is jointly formed by the connector housing and the cover element. At least two wire exit directions can be accomplished due to the exit openings. An electrical connector with such a housing assembly and a connection assembly with such an electrical connector and a mating connector are provided.

### CROSS REFERENCE TO RELATED APPLICATIONS

This application claims the benefit of IN Application No. 202341043322, filed 28 Jun. 2023, the subject matter of which is herein incorporated by reference in its entirety.

### BACKGROUND OF THE INVENTION

The subject matter herein relates to electrical connectors, such as a plug, socket or header e.g., for automotive applications. However, the applicability of the inventive concept is neither limited to electrical connectors nor to the automotive sector. For example, the subject matter may also be used for other types of connectors, such as optical connectors, and may extend to other applications in the field of engineering.

In applications involving the transmission of electrical power and/or electrical signals, spaced-apart technical units may have to be electrically connected via electrical cables or wires in a separable fashion, using electrical connectors. Here, the term electrical wire shall encompass also electrical cable, which themselves comprise at least one electrical wire in the context of the present application.

In systems comprising a branched network of multiple such technical units, often the electrical wires need to run from one and the same “origin” unit to various “target” units. The origin unit may, for example, be part of an interface, while the target units are spread around the system and require the electrical power and/or electrical signals passing through said interface.

Conventionally, each end of the electrical wire only has one connector that is connected to the origin unit. Thus, for each target unit, a separate connector needs to be connected to the origin unit. In highly complex and decentralized systems, this approach excessively increases the number of required connectors.

Another conventional approach is having a single connector from which the electrical wire extends. The electrical wire is then split into multiple “branches” along the way to the respective target units. The effort of routing the electrical wire and all its branches results in immense material, time and space consumption.

There is a need to improve the handling of electrical connectors in general, and facilitate the routing of electrical wires of electrical connectors, in particular.

### BRIEF DESCRIPTION OF THE INVENTION

In one embodiment, a housing assembly for an electrical connector that is inter-mateable with a mating connector includes a connector housing and a cover element attachable to the connector housing, wherein the housing assembly further comprises at least two exit openings for passing electrical wires of the electrical connector, wherein the at least two exit openings are mutually angled at 90° or more, and wherein at least one of the exit openings is jointly formed by the connector housing and the cover element.

The electrical wires can each be part of electrical cables leading out of the housing assembly. The exit openings angled at 90° or more face in different directions that together enclose an angle of 90° or more. In other words, the exit openings are angled by 90° or more. The cover element attachable to the connector housing can for example be attached by means of a latching, screwing, pressing and/or gluing connection.

The abovementioned solution is advantageous, since at least two wire exit directions can be easily accomplished due to the exit openings. There is neither a need to split the electrical wires further down the way, nor the necessity to use separate connectors for each wire. All can be done advantageously with one and the same connector having the housing assembly.

Moreover, for the exit opening jointly formed by the connector housing and the cover element provides the advantage that the corresponding electrical wire does not have to be passed or threaded through the exit opening. It can simply be placed in the exit opening before the cover element is attached to the connector housing. This will be described in further detail below.

The above solution may be further improved by adding one or more of the following optional features. Each of the following optional features is advantageous on its own and may be combined independently with any other optional feature.

According to one possible embodiment, the connector housing may comprises a mating face configured complementarily to the mating connector. Further, the electrical connector and mating connector may be inter-mateable along a mating direction. In particular, the mating face may be arranged on a front side of the connector housing facing in the mating direction towards the mating connector. Moreover, the cover element may be attachable to a back side of the connector housing opposite the mating face. Thus, the electrical wires and their contact terminals may be installed from the back side. After this installation, the back side can be shut with the cover element.

Optionally, the connector housing may comprise internal contact chambers for holding the contact terminals of the electrical wires. The contact chambers may lead into the mating face. Further, the contact chambers may be accessible from the back side opposite of the mating face when the cover element is not attached. After installation of the electrical cables and their contact terminals, the cover element attached to the connector housing may cover, in particular block access to the contact chambers.

According to another possible embodiment, the connector housing may be a single, integral housing part. This reduces the number of separate components of the housing assembly. Likewise, the cover element may also be a single, integral cover part. Alternatively, the cover element may comprise two parts that are individually attachable to the connector housing. The two cover parts may be separate from each other or, optionally, be connected by a film hinge (i.e. living hinge).

Having two cover parts increases the flexibility during the installation of the housing assembly. For example, one cover part can already be attached to the connector housing when a first electrical wire is readily installed. The other cover part is then attached only after installation of a second electrical wire is completed.

According to another possible embodiment, the exit opening not formed jointly by the connector housing and the cover element may be formed jointly by the two cover parts of the cover element. This again provides the advantage that the electrical wire does not have to be passed or threaded through the exit opening, but can simple be placed between the two cover parts to end up in the corresponding exit opening.

To achieve this simple placement of the electrical wire, each of the two cover parts may at least sectionally form a pipe segment. For example, one cover part may form a first half pipe, and the other cover part may form a second half pipe. The first and second half pipes together may form a full pipe surrounding the exit opening in the cover element.

A similar structure can be utilized for the exit opening jointly formed by the connector housing and the cover element. That is, the connector housing may at least sectionally form a first pipe segment, preferably surrounding said exit opening. This first pipe segment may be a half pipe or any angular section of a full pipe with an angle of 360° X°. Advantageously, the first pipe segment provides an additional support of the electrical wire. In particular, bending of the electrical wire can be prevented in the proximity of the connector housing due to the first pipe segment.

Accordingly, the cover element may at least sectionally form a second pipe segment, preferably surrounding the same exit opening as the first pipe segment of the connector housing. The second pipe segment may also be a half pipe or an angular section of a full pipe with an angle of X°. In any case, the first pipe segment and the second pipe segment may jointly form a full pipe. Advantageously, the second pipe segment also provides an additional support of the electrical wire. In particular, bending of the electrical wire can be prevented in the proximity of the cover element due to the second pipe segment.

Optionally, the at least two exit openings may be both jointly formed by the connector housing and the cover element, as described above. In other words, all exit openings may be jointly formed by the connector housing and the cover element or by the two cover parts. This entirely eliminates the necessity to pass or thread the corresponding electrical wire through any exit opening.

In another possible embodiment, the housing assembly may comprise an inner rib extending in a circumferential direction in the exit opening jointly formed by the connector housing and the cover element. With this inner rib, a corrugated tube can be form-fittingly held. Said corrugated tube can advantageously be used for bundling multiple electrical wires running through one and the corresponding exit opening.

If the pipe segments are present, the inner rib may extend one-sidedly or two-sidedly beyond one of the pipe segments and serve for prepositioning the corrugated tube. Preferably, the other pipe segment has a recess on one side or both sides to accommodate the extending inner rib.

As already mentioned, the housing assembly may comprise at least one corrugated tube form-fittingly held in the exit opening jointly formed by the connector housing and the cover element. The corrugated tube helps facilitate the wire routing by bundling multiple electrical wires.

According to another possible embodiment, the housing assembly may comprise at least one end cap for selectively closing at least one of the exit openings. The end cap may be form-fittingly held in the corresponding exit opening similarly to the corrugated tube.

The at least one end cap increases the applicability of the housing assembly. For example, the housing assembly can be used in cases where the number of exit openings in the housing assembly is greater than the number of required exit directions. In particular, the unused exit openings can simply be shut with the at least one end cap.

Alternatively or additionally, the housing assembly may comprise at least one seal ring for sealing a gap between the exit opening and the electrical wire passed through said exit opening. The seal ring may have one or more parallel lead-through openings for passing one or more electrical wires. Further, the seal ring may have radially outwardly extending circumferential sealing lips for abutting the respective pipe segments.

Optionally, the at least two exit openings may be located opposite each other with respect to the connector housing. In other words, the exit openings may be mutually angled at 180°. This allows the electrical wires to be easily routed in two reverse directions.

According to another possible embodiment, the housing assembly may comprise three, four or five exit openings that are pairwise mutually angled at 90° or more. For example, a first, second, third and fourth exit opening are each jointly formed by the connector housing and the cover element, as described above, while the fifth exit opening is solely formed by the cover element. Thus, up to five different cable exit directions can be implemented. Accordingly, more than one end cap and/or seal ring can be provided.

In another embodiment, an electrical connector is provided including a housing assembly according to one of the preceding embodiments and at least two contact terminals held in the connector housing. In particular, the at least two contact terminals may be positioned in their corresponding contact chambers of the connector housing. Depending on the application, more than two contact terminals may be provided.

Due to the functionality and advantages of the housing assembly, which have already been explained above, the electrical connector can be handled easily.

According to one possible embodiment, the electrical connector may comprise at least two electrical wires, each connected to a different contact terminal, wherein the at least two electrical cables are each passed through a different exit opening and routed in directions that are mutually angled at 90° or more. Thus, the electrical connector can be readily used within a branched network of technical units.

In a further embodiment, a connection assembly is provided including an electrical connector according to one of the preceding embodiments and a mating connector, wherein the mating connector comprises at least two mating contacts configured complementarily to the at least two contact terminals of the electrical connector.

The connection assembly benefits from the advantages of the housing assembly. Due to the openings in particular, routing of the electrical wires is facilitated.

The mating connector may also comprise the housing assembly with at least two exit openings for respective electrical wires. The mating connector may be a plug, socket or header arranged at a receptacle or inlet e.g., for automotive applications. Conversely, the electrical connector may be the counterpart to the mating connector and vice versa. That is, the electrical connector may likewise be a plug, socket or header arranged at another receptacle or inlet.

Optionally, the mating connector may comprise a mating-aid mechanism, such as a lever or slider. By manually actuating the lever or slider, a mating process between the electrical connector and the mating connector is driven or at least facilitated. Alternatively, the mating-aid mechanism in the form of the lever or slider may also be arranged on the electrical connector, provided that the mating-aid mechanism does not interfere with any of the electrical wires, corrugated tubes as well as pipe segments and does not block or cover any of the exit openings. Preferably, the mating-aid mechanism is arranged on a side of the housing assembly without any exit opening.

In the following, exemplary embodiments are described with reference to the drawings. The embodiments shown and described are for explanatory purposes only. The combination of features shown in the embodiments may be changed according to the foregoing description. For example, a feature which is not shown in an embodiment but described above, may be added if the technical effect associated with this feature is beneficial to a particular application. Vice versa, a feature shown as part of an embodiment may be omitted as described above if the technical effect associated with this feature is not needed in a particular application.

### BRIEF DESCRIPTION OF THE DRAWINGS

In the drawings, elements that correspond to each other with respect to function and/or structure have been provided with the same reference numeral.

FIG. 1 shows a schematic illustration of a perspective view of a housing assembly according to one possible embodiment of the present disclosure;

FIG. 2 shows a schematic illustration of a perspective view of a housing assembly according to another possible embodiment of the present disclosure;

FIG. 3 shows a schematic illustration of a perspective view of a housing assembly according to another possible embodiment of the present disclosure;

FIG. 4 shows a schematic illustration of a perspective view of a housing assembly according to another possible embodiment of the present disclosure;

FIG. 5 shows a schematic illustration of a perspective view of a housing assembly according to another possible embodiment of the present disclosure;

FIG. 6 shows a schematic illustration of a perspective view of a housing assembly according to another possible embodiment of the present disclosure;

FIG. 7 shows a schematic illustration of a perspective view of a housing assembly according to another possible embodiment of the present disclosure;

FIG. 8 shows a schematic illustration of an exploded view of the housing assembly shown in FIG. 7;

FIG. 9 shows a schematic illustration of a perspective view of an electrical connector according to one possible embodiment of the present disclosure;

FIG. 10 shows a schematic illustration of a perspective view of a connection assembly according to one possible embodiment of the present disclosure; and

FIG. 11 shows a schematic illustration of a partially transparent view of a housing assembly according to another possible embodiment of the present disclosure.

### DETAILED DESCRIPTION OF THE INVENTION

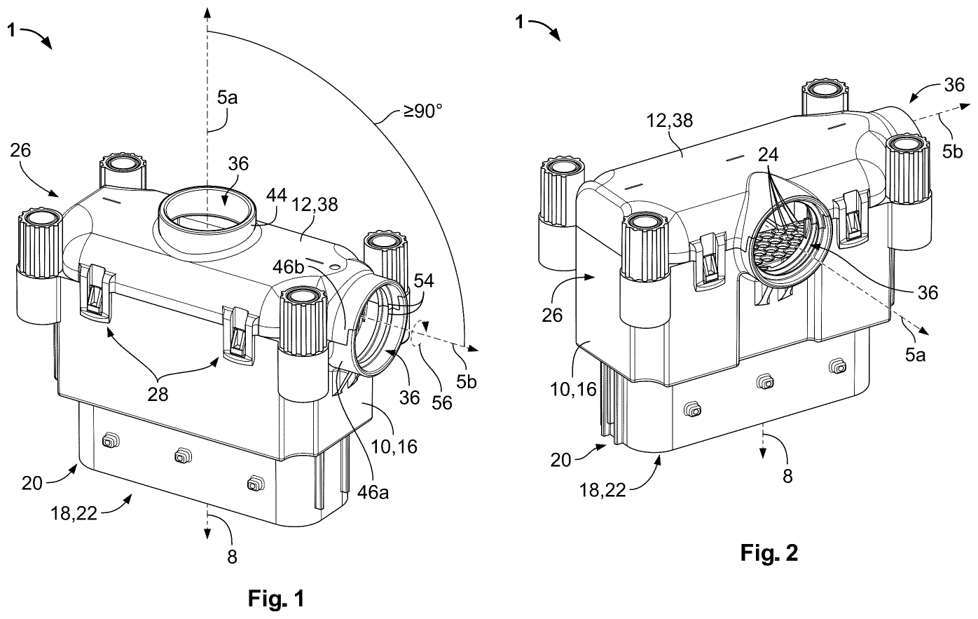

In the following, the structure of a housing assembly 1 is explained with reference to the exemplary embodiments shown in FIGS. 1 to 11. The structure of an electrical connector 2 and a connection assembly 4 will be explained as well.

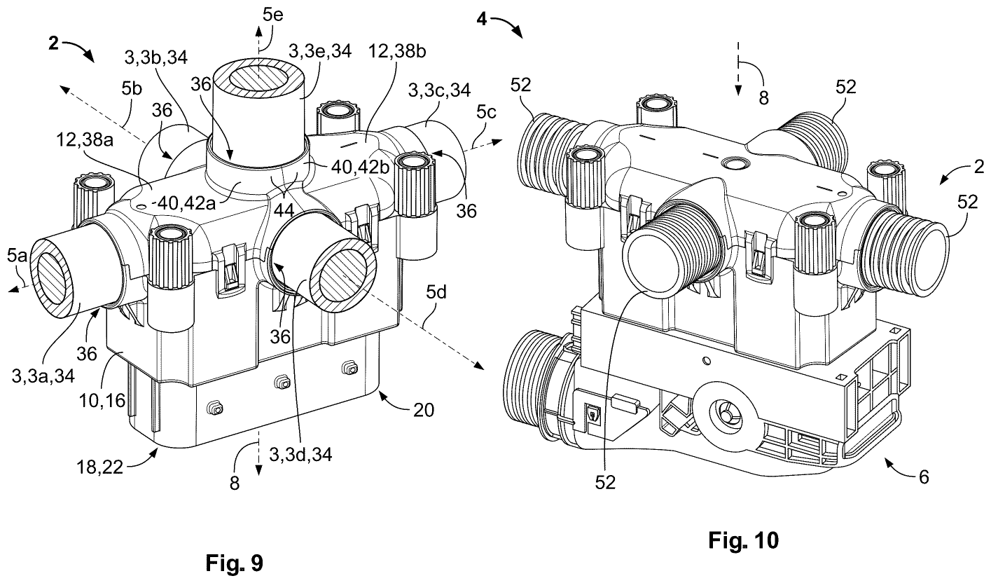

FIG. 1 shows a perspective view of an exemplary embodiment of the housing assembly 1. The housing assembly 1 is meant to be used as part of the electrical connector 2 (see FIG. 9). The electrical connector 2 is inter-mateable with a mating connector 6 along a mating direction 8 (see FIG. 10). The electrical connector 2 and mating connector 6 together form the connection assembly 4.

As shown in FIG. 1, the housing assembly 1 comprises a connector housing 16. The connector housing 16 may be an injection-molded plastic part 10 and may comprise as such a mating face 18. The mating face 18 may face in the mating direction 8 towards the mating connector 6. In particular, the mating face 18 may be arranged on a front side 20 of the connector housing 16 facing in the mating direction 8 towards the mating connector 6.

Further, the mating face 18 may be designed complementarily to a counterpart mating face (not shown) of the mating connector 6. As part of the mating face 18, the connector housing 16 comprises a receptacle 22 for at least sectionally receiving the mating connector 6. In other words, the mating connector 6 is configured to be insertable into the receptacle 22 of the electrical connector 1.

Positioned in the housing assembly 1, the electrical connector 2 comprises at least two electrical contact terminals (not shown) for contacting respective mating contacts (not shown) the mating connector 6. For this purpose, the connector housing 16 may comprise internal contact chambers 24 for holding the contact terminals. The contact chambers 24 may lead into the mating face 18. Further, the contact chambers 24 may be accessible from a back side 26 opposite of the mating face 18, in particular opposite of the front side 20 of the connector housing 16. Depending on the application, more than two contact terminals may be provided.

The housing assembly 1 further comprises a cover element 12 attachable to the connector housing 16. For example, the cover element 12 may be attached to the connector housing 16 by means of a latching connection 28. In particular, the cover element 12 and the connector housing 16 may each comprise latching elements that are pairwise configured to engage in the latching connection 28. Alternatively or additionally, the cover element 12 may be attached to the connector housing 16 by means of a screwing, pressing and/or gluing connection (not shown).

Moreover, the cover element 12 may be attachable to the back side 26 of the connector housing 16. Due to this, the back side 26 can be shut with the cover element 12. In particular, the cover element 12 attached to the connector housing 16 may cover and thus block access to the contact chambers 24. Prior to shutting the back side 26 and covering the contact chambers 24, the contact terminals may be installed in their respective contact chamber from the back side 26.

The contact terminals may each be attached to one end of an electrical wire 3. The electrical connector 2 may comprise at least two such electrical wires 3 for the at least two contact terminals. Preferably, the electrical connector 2 may comprise one electrical wire 3 for each contact terminal.

As will be described in detail below, the housing assembly 1 is especially useful in situations where the electrical wires 3 need to be routed in directions 5a, 5b that are mutually angled at 90° or more. Optionally, the electrical wires 3 can each be part of a different electrical cable 34 of the electrical connector 2. In that case, it is the electrical cables 34 that need to be routed in the directions 5a, 5b.

First, the electrical wires 3 and/or electrical cables 34 need to be lead out of the housing assembly 1. For this purpose, the housing assembly 1 comprises at least two exit openings 36 for passing the electrical wires 3.

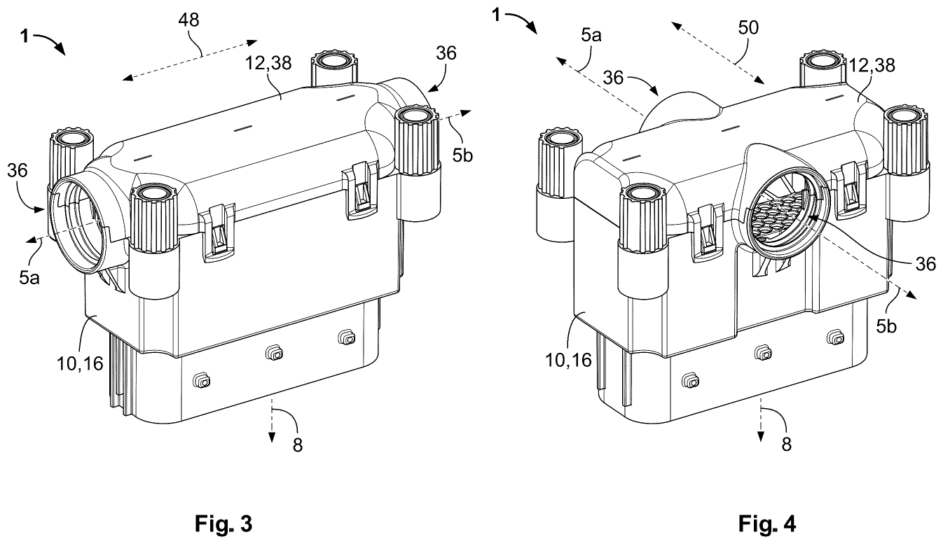

As can be seen in FIG. 1, the at least two exit openings 36 are mutually angled at 90°. Optionally, the at least two exit openings 36 may be angled at more than 90°, up to 180° (see FIG. 3). In the latter case, the at least two exit openings 36 may be located opposite each other with respect to the connector housing 16. In other words, the at least two exit openings may be angled at 90° or more and thereby face in the different directions 5a, 5b that enclose an angle of 90° or more.

One of the exit openings 36 may extend through the cover element 12, in particular, through the center of the cover element 12. Said exit opening 36 may be located at the back side 26 of the connector housing 16 opposite of the contact chambers 24. In the embodiment shown in FIG. 1, the cover element 12 with said exit opening 36 is a single, integral cover part 38.

According to an alternative embodiment shown in FIG. 9, the cover element 12 may comprise two parts 38a, 38b that are individually attachable to the connector housing 16. The two cover parts 38a, 38b may be separate from each other or, optionally, be connected by a film hinge or living hinge (not shown).

The two cover parts 38a, 38b, may jointly form the exit opening 36 at the back side 26 of the connector housing 16. For this purpose, each of the two cover parts 38a, 38b may at least sectionally form a pipe segment 46. For example, one cover part 38a may form a first half pipe 42a, and the other cover part 38b may form a second half pipe 42b. The first and second half pipes 42a, 42b together may form a full pipe 44 surrounding said exit opening 36 in the cover element 12. This provides the advantage that the electrical wire 3 does not have to be passed or threaded through the exit opening 36, but can simple be placed between the two cover parts 38a, 38b to end up in the corresponding exit opening 36 (see FIG. 9).

As can further be seen in FIG. 1, the other exit opening 36 of the housing assembly 1 is jointly formed by the connector housing 16 and the cover element 12. That is, the connector housing 16 may at least sectionally form a first pipe segment 46a, preferably surrounding said exit opening 36. Accordingly, the cover element 12 may at least sectionally form a second pipe segment 46, preferably surrounding the same exit opening 36 as the first pipe segment 46 of the connector housing 16.

This first pipe segment 46a may be a half pipe or any angular section of a full pipe with an angle of 360° X°. The second pipe segment 46b may also be a half pipe or an angular section of a full pipe with an angle of X°. Thus, the first pipe segment 46a and the second pipe segment 46b may jointly form the full pipe.

According to an alternative embodiment shown in FIG. 2, the at least two exit openings 36 may be both jointly formed by the connector housing 16 and the cover element 12, as described above. Herein, no exit opening extends solely through the cover element 12. FIGS. 3 and 4 show further alternative embodiments where the exit openings 36 are arranged opposite to each other with respect to the connector housing 16. In FIG. 3, the exit openings 36 are aligned in a lengthwise direction 48 of the housing assembly 1, while in FIG. 4 an alignment of the exit openings 36 in a transverse direction 50 is shown. Both the lengthwise direction 48 and the transverse direction 50 are preferably perpendicular to the mating direction 8.

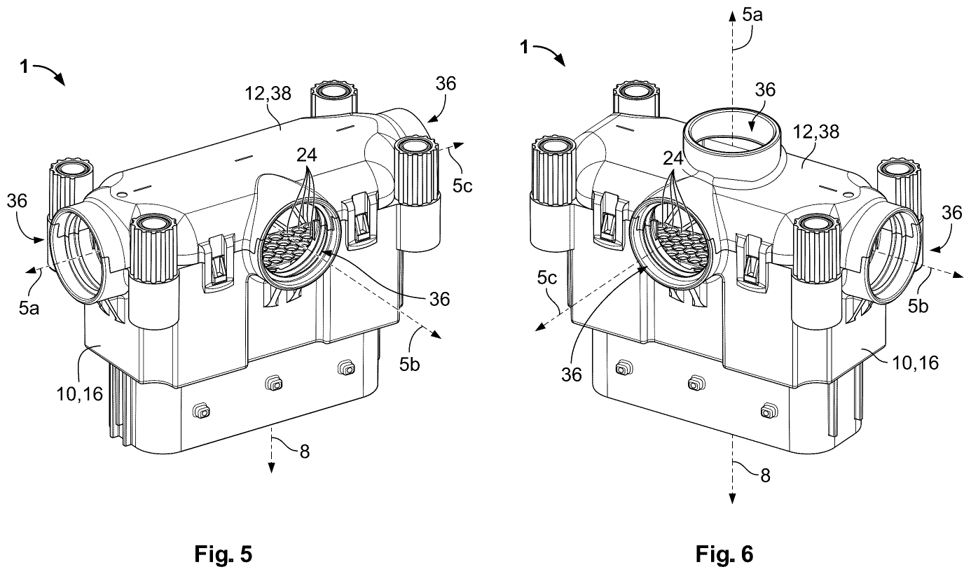

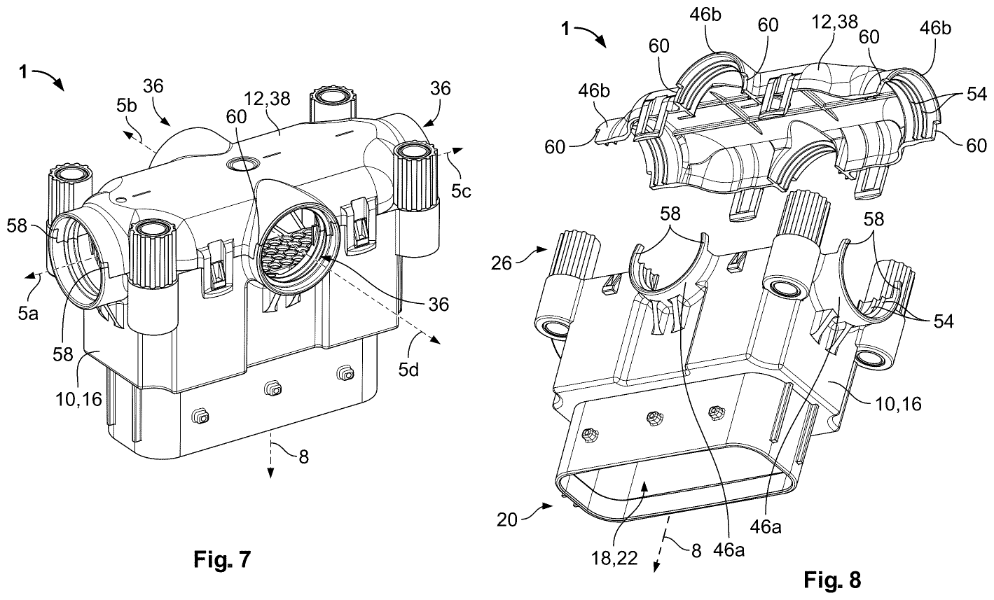

Optionally, the housing assembly 1 may comprise three exit openings 36. This is, for example, shown in the embodiments of FIGS. 5 and 6, respectively. The three exit openings 36 are pairwise mutually angled at 90° or more. The number of exit openings can also be increased to four (see FIG. 7) or five (see FIG. 9). Thus, up to five different cable exit directions 5a, 5b, 5c, 5d, 5e can be realized with five different wires 3a, 3b, 3c, 3d, 3e.

As can be seen in FIG. 9, having two cover parts 38a, 38b increases the flexibility during the installation of the housing assembly 1. For example, one cover part 38a can already be attached to the connector housing 16 when a first electrical wire 3a is readily installed. The other cover part 38b is then attached only after installation of the remaining electrical wires 3b, 3c, 3d, 3e is completed.

Of course, the number of electrical wires is not limited to the number of exit openings. After all, more than one electrical wire may extend through each exit opening. In this case, it may be expedient to bundle these electrical wires in a corrugated tube 52 (see FIG. 10). Accordingly, the housing assembly 1 may comprise at least one corrugated tube 52.

For holding such a corrugated tube 52, the housing assembly 1 may comprise an inner rib 54 extending in a circumferential direction 56 in each exit opening 36 that is jointly formed by the connector housing 16 and the cover element 12. With this inner rib 54, the corrugated tube 52 can be form-fittingly held (see FIG. 10). Optionally multiple inner ribs 54 may be provided for improving the form-fit.

According to an embodiment not shown in the figures, the inner ribs 54 may extend two-sidedly beyond one of the pipe segments 46a, 46b. Alternatively, one of the pipe segments 46a, 46b may comprise an outer annular collar 58 (see FIGS. 7 and 8). Both the extending ribs 54 as well as the annular collar 58 serve for prepositioning the corrugated tube 52. Preferably, the respective other pipe segment 46 has recesses 60 to accommodate the extending inner rib 54 or the annular collar 58.

As can be seen in FIG. 10, the mating connector 6 may comprise a mating-aid mechanism, such as a lever or slider. By manually actuating the lever or slider, a mating process between the electrical connector 2 and the mating connector 6 is driven or at least facilitated. According to an embodiment not shown in the figures, the mating-aid mechanism in the form of the lever or slider may also be arranged on the electrical connector 2, provided that the mating-aid mechanism does not interfere with any of the electrical wires 3, 3a, 3b, 3c, 3d, 3e, corrugated tubes 52 as well as pipe segments 46a, 46b and does not block or cover any of the exit openings 36. Preferably, the mating-aid mechanism is arranged on a side of the housing assembly with no exit opening 36.

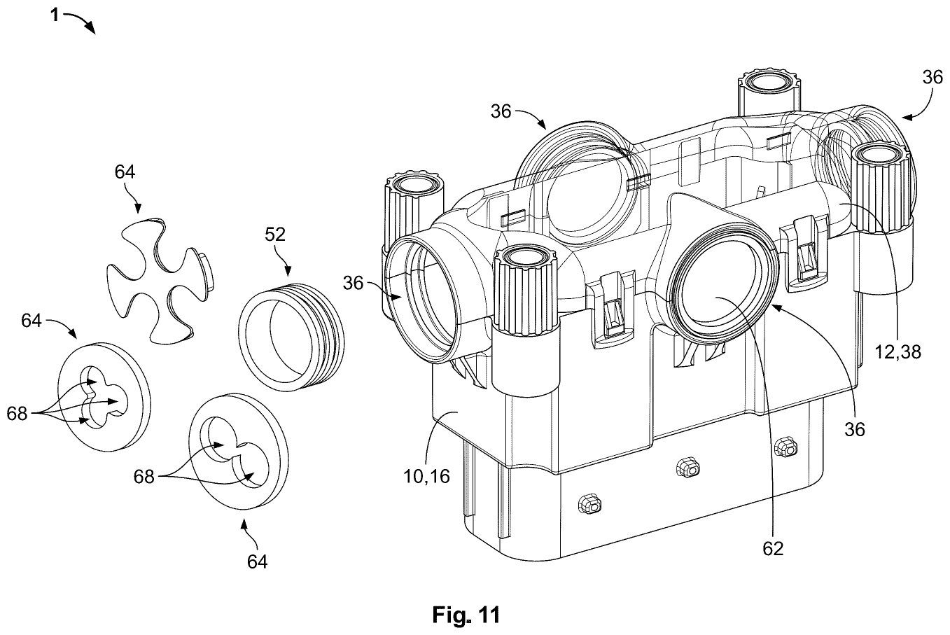

As is shown in FIG. 11, the housing assembly 1 may comprise at least one end cap 62 for selectively closing at least one of the exit openings 36. The end cap 62 may be form-fittingly held in the corresponding exit opening 36 similarly to the corrugated tube 52.

Alternatively or additionally, the housing assembly 1 may comprise at least one seal ring 64 for sealing a gap 66 between the exit opening 36 and the electrical wire 3 passed through said exit opening 36. The seal ring 64 may have one or more parallel lead-through openings 68 for passing one or more electrical wires 3. Further, the seal ring 64 may have radially outwardly extending circumferential sealing lips (not shown) for abutting the respective pipe segments 46a, 46b. Depending on the application, more than one end cap 62 and/or seal ring 64 can be provided.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. Housing assembly for an electrical connector that is intermateable with a mating connector, wherein the housing assembly comprises:
a connector housing; and
a cover element attachable to the connector housing,
wherein the housing assembly further comprises at least two exit openings for passing electrical wires,
wherein the at least two exit openings are mutually angled at 90° or more, and
wherein at least one of the exit openings is jointly formed by the connector housing and the cover element.

2. Housing assembly according to claim 1, wherein the cover element comprises two cover parts that are individually attachable to the connector housing.

3. Housing assembly according to claim 2, wherein the exit opening not formed jointly by the connector housing and the cover element is formed jointly by the two cover parts of the cover element.

4. Housing assembly according to claim 1, wherein the connector housing comprises a mating face configured complementarily to the mating connector, and wherein the cover element is attachable to the connector housing opposite of the mating face.

5. Housing assembly according to claim 1, wherein the connector housing comprises internal contact chambers for holding contact terminals of the electrical wires, and wherein the cover element attached to the connector housing covers the contact chambers.

6. Housing assembly according to claim 1, wherein the connector housing at least sectionally forms a first pipe segment.

7. Housing assembly according to claim 6, wherein the cover element at least sectionally forms a second pipe segment, wherein the first pipe segment and the second pipe segment jointly form a full pipe.

8. Housing assembly according to claim 1, wherein the housing assembly comprises an inner rib extending in a circumferential direction within the exit opening jointly formed by the connector housing and the cover element.

9. Housing assembly according to claim 1, wherein the housing assembly comprises at least one corrugated tube form-fittingly held in the exit opening jointly formed by the connector housing and the cover element.

10. Housing assembly according to claim 1, wherein the housing assembly comprises at least one of an end cap for selectively closing at least one of the exit openings and a seal ring for sealing a gap between one of the exit openings and the electrical wire passed through said exit opening.

11. Housing assembly according to claim 1, wherein the at least two exit openings are both jointly formed by the connector housing and the cover element.

12. Housing assembly according to claim 1, wherein the housing assembly comprises three, four or five exit openings that are pairwise mutually angled at 90° or more.

13. Electrical connector comprising:
a housing assembly including a connector housing and a cover element attachable to the connector housing, the housing assembly including at least two exit openings for passing electrical wires, wherein the at least two exit openings are mutually angled at 90° or more, and wherein at least one of the exit openings is jointly formed by the connector housing and the cover element; and
at least two contact terminals held in the connector housing.

14. Electrical connector according to claim 13, wherein the electrical connector comprises at least two electrical wires each connected to a different contact terminal, wherein the at least two electrical wires are each passed through a different exit opening and routed in directions that are mutually angled at 90° or more.

15. Electrical connector according to claim 13, wherein the cover element comprises two cover parts that are individually attachable to the connector housing.

16. Electrical connector according to claim 13, wherein the connector housing comprises a mating face configured complementarily to the mating connector, and wherein the cover element is attachable to the connector housing opposite of the mating face.

17. Electrical connector according to claim 13, wherein the connector housing comprises internal contact chambers for holding the contact terminals of the electrical wires, and wherein the cover element attached to the connector housing covers the contact chambers.

18. Electrical connector according to claim 13, wherein the connector housing at least sectionally forms a first pipe segment.

19. Electrical connector according to claim 13, wherein the housing assembly comprises three, four or five exit openings that are pairwise mutually angled at 90° or more.

20. Electrical connection assembly comprising:
an electrical connector including a housing assembly and at least two contact terminals held in the connector housing, the housing assembly including a connector housing and a cover element attachable to the connector housing, the housing assembly including at least two exit openings for passing electrical wires, wherein the at least two exit openings are mutually angled at 90° or more, and wherein at least one of the exit openings is jointly formed by the connector housing and the cover element; and
a mating connector including at least two mating contacts configured complementarily to the at least two contact terminals of the electrical connector.
